(19) United States
(12) Patent Application Publication
(10) Pub. No.: US 2008/0160149 A1
(43) Pub. Date: Jul. 3, 2008

(54) Sterilization of Flowable Food Products

(76) Inventors: Maurice Nasrallah, Pleasantville, NY (US); Aidaliz Maldonado Perez, Tarrytown, NY (US); Cara June Turndahl, Brooklyn, NY (US)

Correspondence Address: FITCH EVEN TABIN & FLANNERY, 120 S. LASALLE STREET, SUITE 1600, CHICAGO, IL, 60603-3406, US

(21) Appl. No.: 11/617,178

(22) Filed: Dec. 28, 2006

(51) Int. Cl. A23L 3/16

(52) U.S. Cl. 426/521; 426/231; 96/225

(57) ABSTRACT

Methods of beverage and flowable food product production using steam injection are provided to efficiently destroy microorganisms able to withstand normal pasteurization temperatures. Microorganisms such as Alicyclobacillus acidoterrestris and its spores may be eliminated from fruit juices and the like while minimizing organoleptic degradation due to heating. The apparatus is capable of pasteurizing, blending and controlling the product specifications of a finished beverage in a continuous matter.

### FIELD OF THE INVENTION

This disclosure relates generally to the field of beverage and food production, and in particular the destruction of contaminants (including bacteria, mold, and even spores) from flowable food products by direct steam injection. The disclosed methods are particularly well-suited for destroying spores from fruit juices and the like while maintaining high product quality and superior organoleptic properties as compared to traditional methods of pasteurization.

### BACKGROUND

There are many prior art methods of destroying microorganisms in food and beverage products. Heat has been used to make food items safe for consumption, for example through cooking, since before recorded history. However, beginning with Louis Pasteur's work in the 1800's to extend the shelf life of wine, thermal treatment has been used to methodically kill pathogens and other undesirable organisms in consumables prior to storage, allowing consumers to store those products for longer periods of time without spoilage. Today, a wide variety of liquid products are routinely pasteurized, including milk and other dairy products, juices, beer and other alcoholic beverages, and even liquid egg.

Basic pasteurization techniques eventually gave birth to high temperature short time pasteurization (“HTST pasteurization”) and then ultra high temperature pasteurization (“UHT pasteurization”). More recently, ultra high temperature pasteurization, combined with modern techniques for package sterilization, has allowed the production of a variety of shelf stable food products that may be preserved indefinitely without refrigeration. Such shelf stable products are especially popular in Europe. Certain products, most notably beverages, are also widely available in shelf stable packaging in the United States.

Pasteurization requires food processors to balance the heating temperatures and the heating time of foods to destroy or reduce harmful microorganisms. Over time, experience has taught that by using higher temperatures and shorter holding times, a food processor can heat a flowable food product enough to reduce the level of viable microorganisms that present public safety and storage concerns while also preserving the product's organoleptic properties (taste, texture, color, etc.). However, balancing heating temperature and heating time is not a simple exercise, and in many products, significant time and resources must be spent searching for a suitable heating treatment. Lower temperatures combined with longer treatment time may provide an equivalent microbial kill when compared to high temperatures at shorter times, but may yield very different organoleptic results in the end product. Prolonged heat exposure often imparts a “cooked” flavor to products, and may cause other degradation of organoleptic properties (e.g. odor, flavor, color, etc.). Such a “cooked” flavor decreases the desirability of many ultrapasteurized shelf stable foods.

Food processing with pasteurization is carried out in four basic stages, which can be briefly summarized as heating, holding, cooling, and packaging. During the heating process, the temperature of the food product is raised to a desired point in order to allow for the destruction of certain undesirable microorganisms. Ordinarily, heating is achieved indirectly by conducting heat through a surface that contacts the food product rather than applying heat directly to the food product. A batch method may be used, where a vat of product is surrounded by a heating medium, such as a heated liquid, steam, or heating coils filled with hot water or steam. Product is stirred in the vat to maintain even heating until the contents attain the desired temperature. Since the batch method requires heating a large volume of product through a surface area defined by the walls of the vat, batch pasteurization can take an unacceptable amount of time and space. Therefore, “continuous” processing systems are usually used instead. In continuous systems, smaller volumes of product are continuously moved past a heated surface, referred to as a heat exchanger. A heat exchanger transfers heat from a heating medium to the product to destroy or eliminate microorganisms. Since smaller volumes of product move past the heated surface over a given time period, the product rapidly achieves high temperatures necessary for satisfactory microbial kill. In addition, continuous pasteurization allows further processing of product to begin almost immediately after pasteurization is initiated and to continue simultaneously with the pasteurization process, rather than requiring pasteurization of a large batch of product to be completed prior to initiating any further processing.

There are several varieties of heat exchangers. A “plate heat exchanger” uses very thin, corrugated, heat-conductive plates with a heating medium on one side and liquid food product traveling through the exchanger on the other side. A variety of flow patterns may be used to pass product over the plates. Since the product closest to the surfaces of the heat exchanger will heat much faster than product further away, there is a tendency of the product to cook or burn on the heat exchanger surfaces, which degrades the product's organoleptic properties and may detrimentally affect the performance of the heat exchanger. In order to avoid fouling of the heat exchanger, the plates in a plate heat exchanger may have waffle shaped surfaces designed to impart turbulence in the product while it is being heated to assure uniform heating. Another type of heat exchanger, the “scraped surface heat exchanger,” has blades that scrape the heated surfaces in order to remove product and avoid prolonged heat exposure.

The holding phase of pasteurization takes place after heating, and refers to the process of maintaining the product at elevated temperatures for a desired amount of time. In traditional pasteurization, once heated, the product flows through an insulated holding tube that maintains the product at the required pasteurization temperature for the required time. Heating temperatures and holding times are chosen to cause a desired level of microbial destruction. This level is often referred to in terms of the logarithmic reduction of an organism; e.g., a hundred-fold reduction is referred to as a “2 log reduction” of a target organism. Most of the heat treatment in the pasteurization process is imparted during the holding stage. However, holding time is not a simple matter to determine, since in traditional pasteurization some of the product will necessarily be closer than other portions of the product to the heat exchange surfaces. In addition, heating and cooling rates significantly affect the overall heat treatment, with slower heating/cooling curves significantly increasing the overall heat treatment because of the greater holding time. In addition, since different portions of product travel at different speeds through the holding tubes, and since the speed at which product passes through the holding tube can affect average holding time, flow rate and flow pattern of a liquid through a pasteurizer has a significant effect on the overall heat treatment. Therefore, it is often necessary to evaluate thermal treatment based on the fastest moving portion of food in the holding tubes (which will receive the least heat treatment, and therefore experience the lowest level of microbial kill). In fact, the speed at which a fluid travels through the holding tube further complicates the heat treatment received by any individual portion, since when liquids flow through a tube at slower speeds they experience essentially laminar, or parabolic flow, but at higher speeds experience turbulent flow, producing eddy currents in various directions not in the normal flow path. These eddies can cause certain portions to experience circular, reverse, or angular flow patterns, increasing the holding time of those portions. Therefore, average and fastest portion holding times do not increase linearly with flow speed.

The third basic step of pasteurization is the cooling phase. During the cooling phase, the product is still undergoing changes due to its elevated temperatures. Cooling of the product prevents unnecessary organoleptic degradation due to heating after a desired level of microbial destruction has been achieved. Cooling may simply consist of allowing heat to dissipate through the holding section, or may involve actual refrigeration or use of lower temperature coolants. Rapid cooling puts an end to the heat treatment, slowing or ceasing any alteration to organoleptic properties and microbial kill. Slow cooling, on the other hand, allows the product to continue to experience the effects of raised temperature for a longer period of time, allowing microbial kill to continue, but also allowing the heat to essentially cook the product, resulting in increased levels of molecular denaturation and possibly loss or modification of organoleptic properties.

During or after the cooling stage, the product may be packaged. By the 1960s, packaging equipment suppliers had developed equipment sterilization procedures that could be used to aseptically package pasteurized liquid foods. Aseptic packaging requires sterilizing containers, filling the containers under sterile conditions, and hermetic sealing the containers. By the late 1970s, it was well established that pasteurized products could attain longer shelf life if they were packaged using techniques of aseptic packaging, in which product is packaged in sterile containers under a sterile environment. More recently, “hot fill” processes have become commonplace, where pasteurized products are filled directly into the packaging while still at pasteurization temperatures in order to maintain a low-microbe or microbe free environment.

An alternative to heat exchanger pasteurization is direct steam injection. Rather than relying on indirect heating, steam injection applies a short burst of high temperature steam directly into the product. This method has the potential to produce unacceptable organoleptic results, and has normally been considered unsuitable for many applications, especially when using very high temperature steam. However, steam injection has been used successfully to sterilize certain products, such as milk, as shown in EP 0,617,897 to Arph. In Arph, preheated milk was injected with steam to raise the temperature to 140°-150° F. followed by flash cooling to cool the product and remove water vapor added by steam injection. In published application US 2004/0170731, a method of steam pasteurization is described wherein steam is heated to a temperature no higher than 220° F. and added to raw juice, held for a short time (usually less than 1 minute), and flash cooled to remove the water vapor added by steam injection.

Prior art steam injection processes, however, have been shown to be unreliable, and usually lead to flavor loss. The velocity of steam flowing through a closed system is far greater than that of liquid, resulting in an inconsistent mixture. Since steam will follow the path of least resistance through the system, a temperature gradient can be produced between the steam and the liquid product into which it is injected. Prior art processes also use flash cooling methods, where water is rapidly evaporated from a solution in order to effect cooling. Unfortunately, flash cooling leads to flavor loss. It is believed that this flavor loss is due to the fact that most flavor compounds are more volatile than water. Prior art steam injection processes are also often not cost-effective, since high energy inputs are required to raise product to such high temperatures. Furthermore, these processes may not produce the desired microbial kill for many products.

One of the weaknesses of traditional forms of pasteurization, however, is the inability to effectively kill certain microbes or their spores. Spores are reproductive organisms, usually spawned by fungi or certain bacteria, which are specially adapted for survival under the most inhospitable conditions, including very high temperatures. Pasteurization is not usually intended to “sterilize” food products (i.e., eliminate essentially all microorganisms) because the holding times and temperatures necessary to eliminate nearly all microorganisms, especially spores, would cause too much degradation in organoleptic properties. Sterilization is normally considered a 5-log reduction of microorganisms, resulting in undetectable levels of bacteria, fungi, and yeast. Nevertheless, in some cases sterilization is preferred over pasteurization because difficult to destroy microorganisms capable of surviving pasteurization can be problematic in food production, and may be a health concern and/or significantly affect flavor, odor, or other organoleptic properties.

For instance, in the 1980s a new spore-forming spoilage bacterium was isolated and identified from apple juice. Named Alicyclobacillus acidoterrestris, the bacterium is a motile, spore-forming, rod-shaped microorganism that grows at pH values ranging from 2.5 to 6.0 at temperatures of 25° C. to 60° C. (77° F. to 140° F.). Its spores (which may be central, subterminal, or terminal oval spores) are extremely resistant to high temperatures and acidic environments, and therefore are significant as potential spoilage agents. Bacteria of the Alicyclobacillus genus do not normally present a food safety concern. Some species, however, are known to cause spoilage and produce off-flavors in products (e.g., high-acid juice drinks), even when pasteurized at normal pasteurization times and temperatures. A. acidoterrestris originates in soil, and is known to be a contaminant of fruit and fruit juices.

A. acidoterrestris is known to produce a yellowish, offensive-smelling organic aromatic oil known as guaiacol, as well as other flavor- and odor-altering compounds. Since guaiacol imparts a medicinal-like odor to fruit juices, consumers tend to assume that the presence of guaiacol is a sign of spoilage and/or fermentation. The bacterium causes a flat, sour type of spoilage, and has been implicated in fruit juice spoilage in North America and Europe. The Alicyclobacillus genus is known to be heat resistant, and has an optimum growth temperature between 90° F. and 145° F. at a pH of about 3.5 to 4.0, which is well within normal warehouse storage conditions. If left untreated, Alicyclobacillus organisms are capable of contaminating an entire process line and yielding massive amounts of unsatisfactory product. Due to the ability of the bacterium and its spores to survive normal pasteurization processes and thrive in highly acidic environments, A. acidoterrestris has been the target of significant concern in the fruit juice industry.

Recently, very high pressure and high temperature treatment combinations have been shown to effectively destroy A. acidoterrestris. However, such treatments are unsuitable for commercial purposes and present a significant safety concern due to the extremely high pressure required. For instance, researchers have shown significant destruction of A. acidoterrestris at heat treatments of 71° C. (160° F.) for 10 minutes at 414 MPa (approximately 4,000 atmospheres or 60,000 psi). A similar kill was reported using operating conditions of 90° C. (194° F.) for 1 minute at 414 MPa. See “Inhibitory Effects of High Pressure and Heat on Alicyclobacillus acidoterrestris Spores in Apple Juice,” Lee et al., Applied and Environmental Microbiology, vol. 68 pp. 4158-4161 (August 2002). Unfortunately, operating at such extreme pressures is expensive, requires specialized equipment, and can be quite dangerous.

### SUMMARY OF THE INVENTION

The present disclosure relates to processes of direct steam injection effective to remove highly heat resistant microorganisms from flowable food products and especially heat-sensitive products, such as fruit juices, vegetable juices, fruit or vegetable concentrates, cocktail juices, sugar from cane and beet, and the like, while retaining improved organoleptic characteristics. The disclosure also relates to the destruction of A. acidoterrestris and its spores in aqueous environments, especially fruit and vegetable juice products.

Throughout this specification, the present invention is described in terms of fruit juices (a preferred embodiment). The invention, however, can be used, and is intended to cover, the use of such processes for treatment of any flowable food product.

In order to avoid browning and flavor degradation caused by extended heating times, direct steam injection may be used to treat juices at a high temperature, preferably about 250° F., for short times, preferably less than about 30 seconds, and more preferably for about 3.5 seconds, at relatively low pressure (i.e., generally less than about 35 psig or 2.4 atmospheres). Following rapid heating, rapid cooling is effected by the injection of lower-temperature liquids, (e.g. clean or sterile water). Generally, rapid cooling should be effective to reduce the temperature to below about 190° F. in less than about 20 seconds and preferably to below about 70° F. in less than about 30 seconds. Direct steam injection allows for a much higher heat treatment than traditional heating techniques, such as plate heat exchanger pasteurization or scraped surface heat exchanger pasteurization, since the extremely rapid heating and cooling achieved by direct steam injection followed by injection of a cooling fluid results in the juice only being held at the maximum temperature for a very short period of time. Plate/frame heat exchangers and scrape surface heat exchangers result in burn-on due to the large temperature differential between the heating surfaces and the product, making treatment at temperatures of about 250° F. difficult using traditional pasteurization equipment. The extreme temperatures achieved by direct steam injection are useful for eliminating difficult to destroy microbes or spores from a flowable liquid food product, and only those product components known to, or likely to, carry difficult to destroy microbes of concern need be treated by direct steam injection.

Direct steam injection results in a nearly instantaneous heat transfer, and cold liquid injection thereafter provides nearly instantaneous cooling. In-line static mixers may be used to dramatically boost heat transfer rates, cooling rates, or both, considerably increasing performance over systems using open pipes by essentially eliminating pockets of heat or cold within the aqueous product and thus providing essentially homogenous temperature distribution throughout the juice. Helical elements within the static mixers provide a radial mixing action that rapidly eliminates any temperature gradient in the flowing product without impeding flow through the system. Static mixers can also force pockets of steam within the liquid product to condense and give off latent heat, causing simultaneous heating and dilution of the liquid product. Nearly instantaneous cooling due to direct water injection (or injection of some other cooling fluid) minimizes thermal abuse that can significantly affect flavor.

In order to minimize the time needed to adjust steam flow rate and holding time in order to reach a pre-determined thermal treatment, control strategies involving feed-forward control loops may be utilized. In such a system, instead of waiting for actual feedback data based on heated product and then making necessary adjustments at the point of steam injection, coarse steam heating adjustments are made based on projections made from data relating to incoming product streams. Product streams are monitored upstream from the point of steam injection, and data is forwarded to a steam control system in order to anticipate the treatment requirements of product that will be required when it reaches the steam injection node. Only fine-tuning is then required based on actual flow and temperature feedback data obtained downstream from the injection node. This minimizes the time ordinarily wasted in making large scale changes based on feedback alone, and provides a more consistent and controllable heating process. The feed-forward system also eliminates a significant amount of wasted juice by reaching target temperatures quickly and maintaining a more consistent heat treatment (i.e., avoiding temperature fluctuation outside of the proscribed limits for safety or organoleptic concerns).

After steam-sterilization, and after accounting for the water added by steam injection and cooling water injection, the juice may be combined with other components in order to create a finished juice product. This finished product may be further pasteurized in order to eliminate any contamination from the other components added after steam injection. Alternatively, mixing of compounds and pasteurization may be accomplished in one step if the temperature and flow of the juice and other components are regulated so that addition of components to the steam-heated juice raises the temperature of those components to pasteurization conditions for a sufficient period of time.

The direct steam injection processes disclosed herein may be effectively used to produce a number of flowable food products, including juice products consisting of 100% natural juice, juice products comprising about 10% or more juice, and other juice products. The high temperature short time direct steam injection processes of this invention are significantly less expensive and energy intensive than equivalent plate and frame heat treatments, and provide a higher quality product with significantly superior organoleptic characteristics.

### BRIEF DESCRIPTION OF THE DRAWINGS

FIG. 1 shows a comparison of heating curves for indirect heating versus direct steam injection.

FIG. 2 is a simplified diagram of an in-line steam injection process.

FIG. 3 is a diagram of an in-line steam injection system.

FIG. 4 is diagram of an alternative in-line steam injection system.

FIG. 5 demonstrates the operation of a stem-like steam release valve.

FIG. 6 is a block diagram of a feed-forward control system.

FIG. 7 is a graph of temperature of an aqueous-based flowable food product heated by direct steam injection without a feed-forward control system.

FIG. 8 is representative of a graph of temperature of a flowable food product heated by direct steam injection utilizing a feed-forward control system.

### DETAILED DESCRIPTION

A flowable food product, such as a fruit or vegetable juice, juice concentrate, fruit or vegetable puree, or sugar from cane and beet, is processed by direct steam injection in order to maximize microbial kill and produce a sterile product. In one embodiment, juice is transferred from a holding tank to a heating apparatus and direct steam injection is used to nearly instantaneously (generally less than about 30 seconds and preferably less than about 5 seconds) raise the temperature of the juice to a pre-selected temperature, such as about 250° F., for a short time interval, preferably less than about 30 seconds. Pressure in the “sterile zone,” where steam injection and heating take place, is preferably maintained at about 25 to about 35 psig to maintain temperature, avoid flashing, and maintain satisfactory levels of microbial reduction. Direct steam injection followed by direct injection of cooling fluid allows for a much faster and more controlled heat treatment than traditional heating techniques, such as plate heat exchanger pasteurization or scraped surface heat exchanger pasteurization, since the extremely rapid heating and cooling results in the juice only being held at the maximum temperature for a very short period of time (generally less than 30 seconds, preferably less than about 15 seconds, and more preferably about 3 to about 5 seconds). Direct steam injection also avoids the burn-on frequently experienced by plate/frame heat exchangers and scrape surface heat exchangers. Direct steam injection is especially useful for eliminating or destroying certain difficult to destroy bacteria and spores, such as Alicyclobacillus acidoterrestris. Direct steam treatment need only be applied to those ingredients of the product known to, or likely to, carry the difficult to destroy microorganisms, thus avoiding unnecessarily raising the temperature of the entire finished product to an effective pasteurization temperature.

In-line static mixers are preferably positioned directly after the point of steam injection to aid in rapidly incorporating the steam into the product. Helical elements within the static mixers provide a radial mixing action that separates the liquid into streams and then forces these streams back together, rapidly eliminating any temperature gradient within the product traveling through the static mixer without interrupting or halting product flow. In-line static mixers in the holding section dramatically boosts heat transfer rates by forcing steam pockets within the aqueous product to condense and give off latent heat, considerably increasing performance over systems using open pipes under either laminar or turbulent flow.

A pressure-regulating valve downstream from the in-line static mixer maintains the line pressure between 25 to 35 psig during steam injection and mixing in order to avoid product flashing, and ensuring that all the steam condenses into the juice concentrate.

The juice is next routed to a cooling section, where cooling liquid is injected directly into the hot juice. The cooling liquid may be clean, and preferably sterile, cold water treated by ultraviolet irradiation, reverse osmosis, or equivalent sterilization means. Nearly instantaneous cooling (generally to less than about 190° F. in less than about 30 seconds, preferably less than about 5 seconds) due to direct water injection minimizes undesired thermal abuse possible after continued high temperature exposure that can significantly affect flavor. In-line static mixers are positioned directly after the point of cold water injection, again in order to aid in rapidly stabilizing the temperature. Helical elements within the static mixers provide a radial mixing action that rapidly disburses pockets of cold water throughout the product, cooling the hot juice, providing a homogenous product, and eliminating any temperature gradient within the product traveling through the static mixer.

If the pasteurization temperature is below a predetermined pasteurization temperature, a divert valve located downstream from the second static mixer will divert the flow of the product towards the drain, thus, preventing inadequately pasteurized product from moving forward in the process.

If a predetermined pasteurization temperature is met, the juice is then transferred to a batch tank for holding and/or further processing. Additional pasteurization may be performed prior to packaging. The juice may be packaged using any method suitable for liquids, including aseptic or hot fill processes that provide a sterile, shelf stable juice product. The juice may also be packaged using a cold-fill process.

A feed-forward control scheme may be used to maximize heating and cooling efficiency. A feed-forward loop minimizes the time needed to adjust steam flow rate and holding time. Instead of waiting for feedback data based on heated product and then making necessary adjustments, coarse heating adjustments are made in advance based on energy balance projections made from an algorithm relating to incoming product streams. Only fine-tuning is then required based on feedback of the steam-heated product. This minimizes time and resources ordinarily wasted by controlling heating based solely on feedback data from heated product.

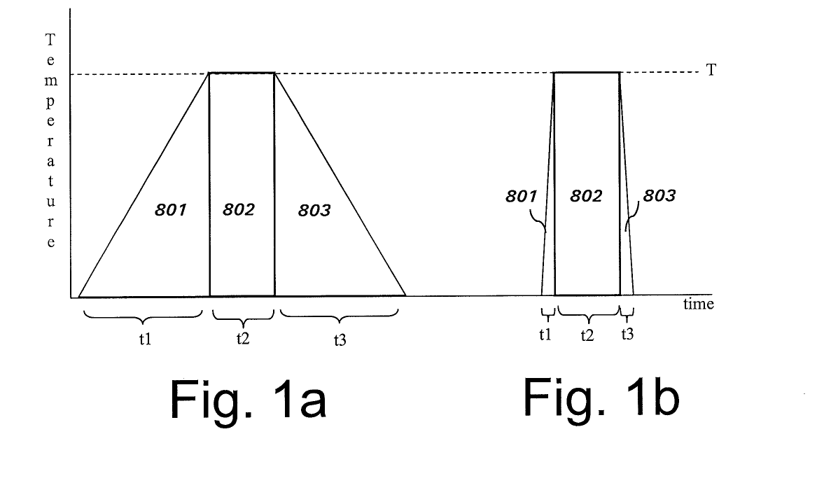

The control system described above greatly increases the reliability of commercial steam injection at temperatures of about 250° F. or more. The almost instantaneous heating effected by direct steam injection and the almost instantaneous cooling effected by direct injection of cooling fluid substantially reduces the heat abuse that would otherwise result from pasteurization. As shown in FIG. 1, slower heating and cooling dramatically increases the overall heat treatment, even though that additional heat treatment will not be effective to further reduce the population of a target microorganism, such as Alicyclobacillus acidoterrestris. FIG. 1a shows a normal pasteurization curve, consisting of heating, holding at a pasteurization temperature T, and cooling. Time of heating is shown along the x-axis, and temperature is shown along the y-axis. For a first period of time, “t1,” the product is heated to a desired preset temperature, T, which is sufficient to destroy a particular target organism. The product is held at this preset temperature for a second period of time, “t2,” and then cooled for a third period of time, “t3.” In FIG. 1a, indirect heating is used to bring the product temperature up to a preset level. The total heat treatment represents the area under the heating curve. As can be seen, significant heat treatment of the product is experienced during heating (801) and cooling (803). However, since the target microorganism(s) predetermined temperature T for a predetermined hold time (thermal death time curve), only heat treatment (802), which takes place during t2, actually results in a significant destruction of the target organism. Heat treatments (801) and (803) do not significantly contribute to the elimination of microorganisms, but can possibly have a detrimental effect on organoleptic properties. By using direct steam injection followed by direct injection of cooling liquid, as in FIG. 1b, the heating time (t1) and cooling time (t3) are greatly reduced, limiting heat exposure during heating (801) and cooling (803). This essentially limits the heat treatment to the heating time and temperature necessary to kill the target microorganism, thus minimizing the risk of detrimentally affecting organoleptic properties. In addition, direct steam injection dramatically decreases overall production time by speeding up the overall heating and cooling process (t1+t2+t3) by essentially eliminating the heating and cooling periods, allowing increased rates of juice production.

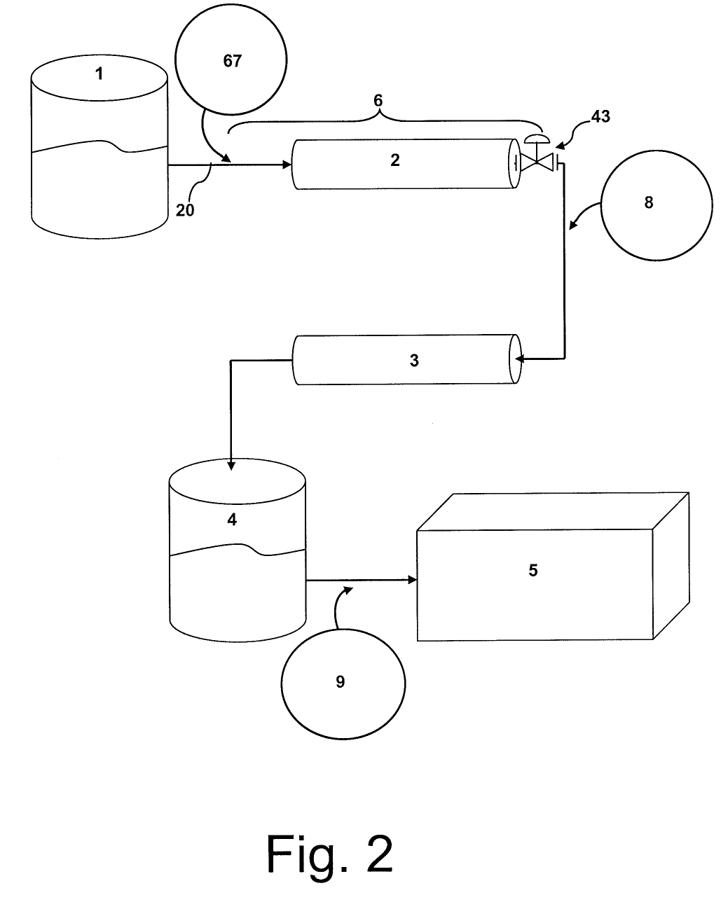

FIG. 2 shows a simplified diagram of a juice manufacturing process using direct steam injection. Juice is released from the holding tank (1) and flows along forward pathway (20). Steam injection apparatus (67) interfaces with the juice flow pathway (20) at a steam injection node. Release of high temperature steam establishes a sterile zone (6) extending from the steam injection apparatus (67) to a downstream pressure control valve (43). The released steam is preferably at a temperature of about 245-255° F. in order to destroy organisms such as Alicyclobacillus acidoterrestris. In juice processing, a 5-log reduction of Alicyclobacillus acidoterrestris is usually considered sufficient to avoid spoilage or adverse organoleptic effects. As the juice passes along the flow path (20), it is injected with high temperature steam calculated to raise the juice to a pre-determined pasteurization or sterilization temperature within seconds. The steam-heated juice then flows to a first static mixer (2), which serves as a holding tube and also disperses the injected steam throughout the juice stream. After exiting the mixer (2), a cooling liquid (8) is injected into the juice stream. The cooling liquid (8) should be of sufficient temperature and flow rate to cool the juice stream to a desired temperature. The cooling liquid (8) may be of low enough temperature to return the juice to an essentially ambient temperature or, alternatively, cooling liquid (8) temperature and flow may be set so that the combined cooling liquid and juice streams will have normal pasteurization temperatures (for example, about 190° F.) or higher, so that dissipating heat from the steam-heated juice pasteurizes the incoming stream of cooling liquid (8). The cooling liquid (8) may be water or other non-juice components that are desired in the final product. After cooling liquid (8) has been added directly to the juice stream, a second static mixer (3) disperses the cooling liquid evenly throughout the juice stream, assisting the cooling process by uniformly distributing the lower temperature cooling liquid throughout the higher temperature juice. The cooled juice product may then be directed to a batch tank (4) for temporary storage. Alternatively, the juice product stream may proceed directly to a packaging system (5). The juice product from the batch tank (4) may be combined with other liquids or additives (9), and may also be further pasteurized. The juice product may then proceed to a packaging system (5), which is preferably an aseptic or hot fill packaging machine.

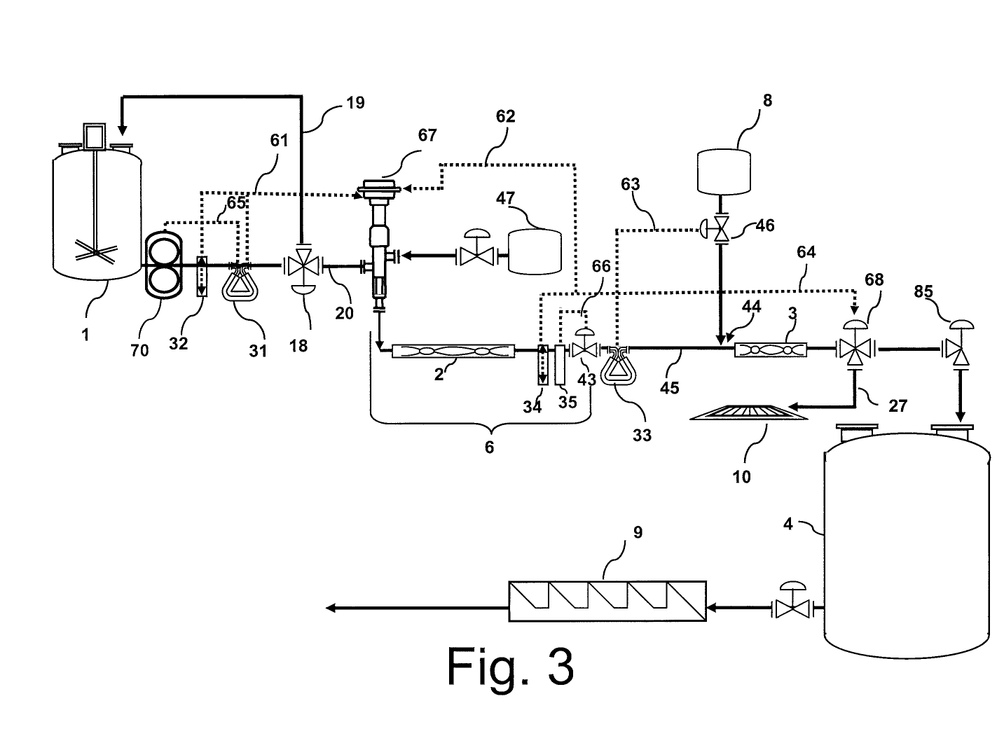

A more detailed diagram of one possible direct steam injection fruit juice system is presented in FIG. 3. Juice concentrate is held in a holding tank (1) prior to processing. A three-way valve (18) is located downstream of a juice concentrate holding tank (1). The three-way valve can be instructed to direct juice exiting the holding tank (1) either to a “recycle” position which directs concentrated juice down a recycle path (19) that leads directly back to the holding tank, or a “forward” position, which directs the flow of juice concentrate on a forward path (20) towards a steam injection apparatus (67). During start-up and initial processing, juice concentrate is set to recycle the juice concentrate back to the holding tank along recycle path (19). A target flow rate is chosen for the juice concentrate, and until that target level is reached, the three-way valve (18) remains in the recycle position. A flow meter (31) provides instructions to a pump (70) through a control loop (65), causing the pump to speed up or slow down in order to reach and maintain the target flow rate.

The flow rate and temperature of the stream of juice concentrate exiting the holding tank (the “feed stream”) are carefully monitored via a feed flow meter (31) and feed stream thermometer (32). The feed flow rate and feed temperature are used to calculate the required steam flow rate to raise the juice concentrate from its feed temperature (the temperature at which it exits and travels away from the holding tank) to the desired steam pasteurization or sterilization temperature. The desired steam pasteurization or sterilization temperature is chosen based on the temperature and flow necessary to raise the stream of juice concentrate to a desired temperature in order to achieve a predetermined destruction level of targeted microorganisms. For instance, the juice stream may be raised to a temperature of about 245° F. to about 255° F. for a predetermined time in order to achieve a 5-log reduction of Alicyclobacillus acidoterrestris. A feed-forward algorithm projects a desired level of valve-opening in order to release a flow of steam capable of raising the feed stream to the desired pasteurization/sterilization temperature, and a feed-forward loop (61) transmits this information to the steam injection apparatus (67).

When the targeted juice feed flow rate and feed temperature are achieved, the three-way valve (18) switches from the recycle path (19) to the forward path (20), forwarding juice concentrate toward the steam injection apparatus (67). By the time that the juice flow reaches the steam injector valve, the valve has received relevant information relating to the feed stream's flow rate and temperature, and has adjusted its output to a level sufficient to raise the temperature of the juice approximately to the target pasteurization or sterilization temperature.

Injection of high temperature steam sterilizes the piping near the steam injection apparatus (67), establishing a sterile zone (6) through which the feed stream will pass. The steam is cooled downstream from the sterile zone via injection of cold process water from a cold water tank (8). Preferably, process water is added to the steam in about a 1 to 1 flow ratio in order to avoid pipe hammering. The process water is clean and may be de-ionized or treated with ultraviolet light, reverse osmosis, or the like, and is preferably sterilized prior to its injection into the flow path of the steam/juice.

Fine adjustments to the heating process may be made by a traditional feedback loop (62), which uses thermometer (34) to monitor feed stream conditions downstream of the steam injector valve, and based on this data varies the steam flow into the steam injector to ensure that the feed stream will be raised to the target pasteurization/sterilization temperature. The steam injection apparatus (67) discharges high pressure steam from a steam reservoir (47) directly into the juice concentrate stream. A separate control loop (63) may also adjust the rate of incoming cooling liquid by opening or closing a valve (46) in order to compensate for increases or decreases in the amount of water vapor added by steam injection.

The temperature monitor (34) may also activate a divert valve (68) downstream from the temperature monitor (34) and flow monitor (33) while making feedback adjustments. If the juice has not reached the desired temperature after steam injection, control loop (64) causes juice to be diverted along disposal pathway (27) to a drain (10) or equivalent disposal means.

Smoother control for the feedback loop is achieved by keeping the incoming flow of juice as constant as possible. Another feedback loop (65) measures the flow rate of the juice using flow meter (31) and adjusts the speed of pump (70) in order to maintain a relatively constant flow rate of juice into the steam injector.

A first in-line static mixer (2) is located downstream from the steam injection apparatus (67) in the sterile zone (6). The static mixer replaces the traditional holding tube, and churns the juice concentrate and steam mixture into a homogenous product stream by dispersing and condensing the steam throughout the stream of juice. This avoids temperature fluctuations in the product stream and maintains consistent product output. The elevated temperature caused by steam injection is maintained for a predetermined time as the product stream passes through the static mixer. The product stream may be held at the target temperature for a time period sufficient to achieve a preset level of destruction of a targeted microorganism. For instance, juice flow may be set so that the juice stream takes approximately 3.5 seconds to pass through the first static mixer while held at an elevated temperature of about 245° F. to about 25° F., essentially guaranteeing a 5-log reduction of Alicyclobacillus acidoterrestris.

Pressure is monitored by a pressure monitor (35) located downstream of the first static mixer. A pressure-regulating valve (43) downstream from the monitor (35) maintains the line pressure at a pre-set elevated level, preferably about 30 psig, to avoid product flashing due to the addition of high temperature steam since the product is above its boiling point. The pressure-regulating valve (43) may be adjusted by the pressure monitor (35) through a pressure control loop (66). Maintaining elevated pressure also ensures that the steam injected into the feed stream will condense and become a part of the feed liquid.

In order to cool the pasteurized/sterilized product stream, a cooling fluid, such as cold water, is injected into the system at a cooling fluid injection node (44) attached to a source of cooling fluid (8) downstream from the first static mixer. The cooling fluid is preferably clean so that it will not contaminate the product stream, and is more preferably sterile so that further pasteurization is unnecessary. It is preferred to add the cooling fluid to the product stream in about a 1 to 1 flow rate ratio to cool the heated product stream to a pre-set temperature and to prevent pipe hammering and product flashing at the downstream batch tank (4) containing finished product. A second in-line static mixer (3) evenly disperses the cooling fluid throughout the product stream to maintain an even flow and consistent temperature. Cooling fluid may be added at any point after heating, but is preferably added downstream from the pressure control valve (43) in order to avoid product flashing, and also to avoid the need for equipment capable of injecting cooling fluid into a high pressure zone.

After cooling, the product stream, which has been diluted with condensed steam and cold water, is emptied into a batch tank (4). Based on measured flow rates of the feed stream, injected steam, and cold water streams, a control loop may determine whether further dilution is necessary to arrive at a desired Brix (or other concentration parameter). The product created by this process may be a finished juice, or may be further processed by combination with other ingredients, such as high fructose corn syrup, water, artificial or natural flavors, artificial or natural colors, or vitamins or minerals to form a variety of juice products. Preferably, if other ingredients are added, the entire mixture is pasteurized using a traditional heat exchanger (9) in order to eliminate unwanted microbes that may have entered the product through the other added ingredients.

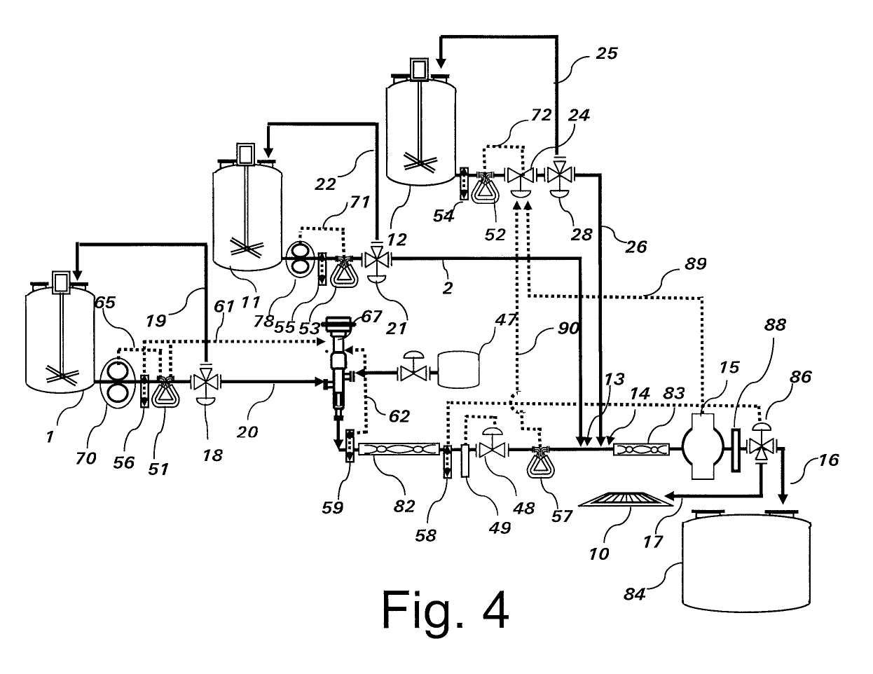

Alternatively, as shown by example in FIG. 4, multiple product streams may be held at elevated temperatures and combined in one step so that addition to steam-heated juice raises the temperature of all other components to pasteurization or sterilization temperatures and avoids the necessity of further pasteurization. FIG. 4 illustrates the continuous blending of three streams of liquid from three different holding tanks: juice concentrate (1); bulk sweetener, such as high fructose corn syrup or sucrose (11); and water or other cooling fluid (12). The water or cooling fluid may be adjusted to control the temperature of the final blend of these streams depending on whether the final blend will be hot, cold or aseptically filled.

A supply of juice concentrate compound is held in a juice concentrate holding tank (1). A temperature monitor (56) and flow meter (51) are positioned between the juice concentrate holding tank (1) and the divert valve (18). Water is contained in water holding tank (12); the temperature is adjusted to the desired level using traditional methods (not shown). The water tank is attached to a temperature monitor (54), a flow meter (52), and a control valve (24), and connected to the juice flow path via pathway (26) at a node (14) downstream from the point of steam injection. High fructose corn syrup or sucrose syrup is stored in a third separate holding tank (11), which is connected to a pump (78), a temperature monitor (55), a flow meter (53), a divert valve (21), and a syrup flow path (23).

The juice making process begins by blending a juice concentrate compound in the juice concentrate holding tank (1) and separately filling the high fructose corn syrup holding tank (11) and water tank (12).

Water temperature is controlled by a temperature control loop (not shown). A target temperature is set for the water so that combining steam-heated juice and water will raise the temperature of the water to a temperature effective to pasteurize the water and eliminate unwanted contaminants. If the water exiting water tank (12) falls below the target temperature, thermometer (54) sends a signal to water control valve (28) to send the water stream along recycle path (25), which returns the water to the water tank for re-heating. A signal is also sent to alter the temperature of the water exiting hot water holding tank (12). When processing begins, the water control valve (24) will be set in recycle mode, diverting water back to the holding tank (12) via recycle path (25) for re-heating until a target flow rate and temperature are established, and until juice production is ready. After the water target temperature has been reached, and the system indicates that juice production is ready to begin, control valve (24) is switched to forward mode, directing the water stream along forward path (26).

Similarly, a stream of high fructose corn or sucrose syrup starts in recycle mode in preparation for juice processing, beginning from the syrup holding tank (11) and diverted by syrup control valve (21) to recycle pathway (22) until a target flow rate is established. Syrup flow monitor (53) and thermometer (55) are located upstream of syrup divert valve (21). When the system is ready for juice pasteurization or sterilization and flow meter (53) indicates that the corn syrup stream has reached its target flow rate, the divert valve (21) switches to forward mode and directs the stream of heated syrup along forward pathway (23).

The juice stream begins in cold juice recycle mode at refrigerated to ambient temperature to establish a target flow rate. Juice concentrate is released from the juice concentrate holding tank (1) and diverted back to the holding tank (1) by the juice control valve (18) via recycle pathway (19). During cold juice recycle mode, the steam injection zone, located between the steam injection apparatus (67) and the pressure-control valve (48), is pre-sterilized at about 255° F. Steam from this cleaning process eventually condenses to sterile water in the holding tubes (82) and (83), which comprise in-line static mixers. During pre-sterilization, this condensate is discharged as waste by a downstream divert valve (86), which diverts waste along pathway (17) to a drain (10) or other disposal means.

Once the steam injection zone has been sterilized and the juice recycle stream has reached a desired flow rate (as measured by flow meter (51)), the juice divert valve (18) switches from recycle mode to forward mode, releasing a stream of juice concentrate along forward pathway (20) toward the steam injection apparatus (67). Based on information regarding initial flow rate and temperature of the juice concentrate stream obtained from flow meter (51) and thermometer (56), a feed-forward algorithm calculates the amount of steam required to raise the juice stream to a pre-set sterilization or pasteurization temperature, and transmits this information via feed-forward control loop (61) to alter the release rate of steam. Steam from a steam reservoir (47) is released into a steam injection apparatus (67), and nearly instantaneously penetrates the juice concentrate, efficiently mixing with the concentrate causing rapid heating to precise pasteurization or sterilization temperatures. A thermometer (59) monitors the temperature of the steam. If the thermometer indicates that the juice stream has not reached the sterilization temperature, a feedback loop (62) adjusts the rate of steam release by the steam injection apparatus (67) accordingly, so that subsequent product will attain target temperature and target flow.

The steam-heated juice stream then enters an in-line static mixer (82), which serves as a holding tube to complete the pasteurization or sterilization process, and also thoroughly mixes the juice and steam while maintaining a forward flow path. The static mixer preferably contains at least four mixing elements. Mixers appropriate for this purpose include the Chemineer KMX Series and Komax M Series Mixers. A conventional holding tube may alternatively be used, or another type of mixing device, but an in-line mixer is preferred so that flow of juice is turbulent and mixing may take place continuously, thus significantly reducing the length of the holding tube when compared to a typical conventional holding tube with laminar flow. The in-line static mixer (82) provides a stream of juice with a consistent elevated temperature that flows downstream toward a post-steam injection flow meter (57) and thermometer (58). The post-injection flow meter (57) may increase or decrease the flow of water by sending a signal to the water control valve (24) through a control loop (90). A feedback pressure control loop triggered by a pressure monitor (49) maintains the sterile zone's pressure between 25 and 35 psig, by regulating the line pressure via pressure-regulating control valve (48). This ensures that the steam condenses into the product, giving off its latent heat. In order to maintain product quality, it is recommended that juice concentrate that does not reach target temperature according to thermometer (58) may be diverted as waste along a waste disposal path (17).

As juice flows from the holding tank (1) to the steam injection apparatus (67), the syrup control valve (21) and hot water control valve (24) are sent signals indicating that juice flow has begun, and, if flow meters (52) and (53) and thermometers (54) and (55) indicate that the fluids' respective target flow rates and temperatures have been achieved, syrup and hot water are routed along forward paths (23) and (26), respectively. The syrup stream and water streams merge with the flow path of pasteurized/sterilized juice at nodes (13) and (14), respectively. As juice exits the first static mixer (82), it converges with the syrup flow path (23) and water flow path (26). The order in which the fluids intersect is not significant, and in fact the hot water flow path (26) and syrup flow path (23) may intersect before reaching the juice flow path.

Contact with the lower temperature water and syrup, which were not injected with steam, quickly cools the hot juice concentrate. After the three feed streams are combined into one flow path, the combined streams enter a second static mixer (83) that blends the three streams together into one stream of a consistent temperature, cooling the steam-heated juice through mixing with the lower-temperature components. The second static mixer (83) may be of the same type as static mixer (82), or of a different type. The three streams of liquid are continuously blended in the static mixer (83) to produce a finished juice product. Preferably, the predetermined temperatures of each of the three streams were selected so that the homogenous mixture created by the combination of the three streams has a temperature at or above a desired pasteurization temperature so that further pasteurization is not necessary.

Concentration and quality of the finished juice product may be monitored by use of an in-line Brix monitor (15) and pH meter (88). A Brix control loop controls and adjusts the Brix of the finished juice product by manipulating the water control valve (24) through a feedback control circuit (89). Water is added if necessary to achieve a target Brix, and juice that does not fall within pre-set Brix tolerances is diverted to a drain (10) by a divert valve (86) and a divert pathway (17). Product that does fall within pre-set Brix and temperature tolerances will be diverted to the finished product flow path (16) that leads to a finished product filler surge tank (84) for packaging or further processing.

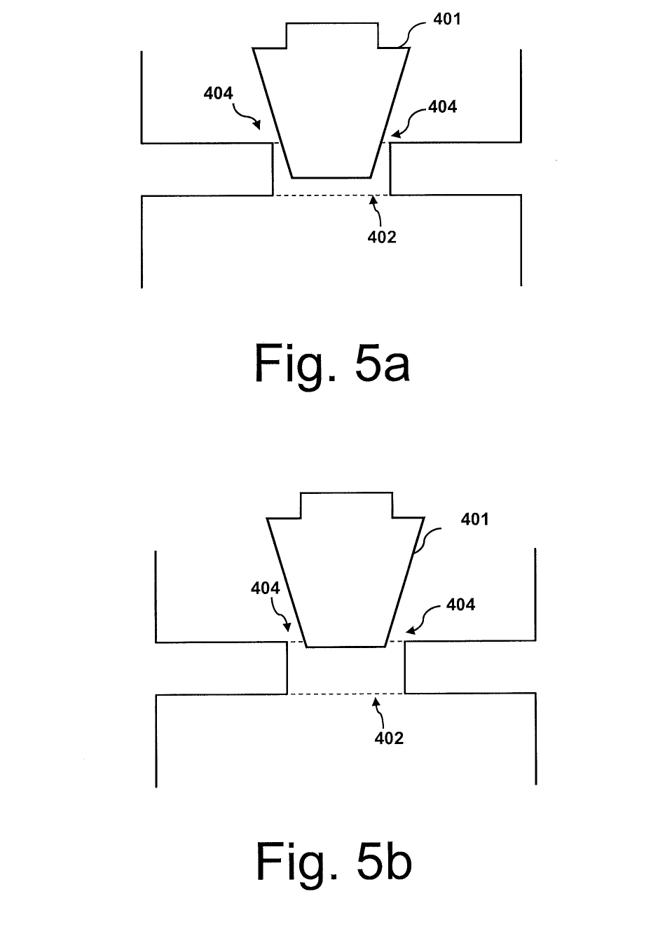

Adjustments in the position of the steam injector valve control the heating of juice by varying the amount of steam escaping the valve. Steam flow and temperature are calculated to raise the juice stream to a predetermined pasteurization/sterilization temperature calculated based on the temperature and flow rate of juice entering a steam injection node. The structure of the valve itself may be of a variety of shapes, sizes, and configurations. The steam injector valve may be a stem-like valve configured to act like a tapered piston, moving in and out of a steam release orifice in order to provide a steam flow that may be quickly and easily altered in response to the feed-forward and feedback control loop. The steam injection apparatus may also contain multiple orifices each equipped with a valve piston. One possible piston-like valve is shown in FIG. 5. The piston (401) may be moved linearly in and out of a steam release orifice (402) in order to predictably vary the amount of steam released from the steam release orifice. Preferably, the surface of the piston that interfaces with the steam release orifice has a tapered shape, such as the frusta-conical shape shown in FIG. 5. A frusta-conical or otherwise tapered interface surface on the piston allows the release of steam to be more easily controlled as the piston is drawn linearly away from the orifice. As shown in FIG. 5a, as the frusta-conical piston moves away from the orifice, an annular opening (404) between the orifice and piston will allow the release of steam. As the plug moves away from the orifice, the annular opening (404) increases in size, as shown in FIG. 5b. Without this tapered shape, the piston would merely turn the release of steam on and off, and would not provide the feed forward and feedback loops with as much control over the release of steam.

The production line preferably includes a feed-forward control system to predict required heating conditions, which is preferably coupled to a feedback control loop to further refine the heating system based on actual product temperature. A feed-forward control system allows for exceptional control of a product stream's temperature, not only saving time and energy, but allowing for higher volume production. By maintaining a more consistent product temperature, the feed-forward control system eliminates a significant amount of necessary diverting and/or recycling of product, allowing usable product to be manufactured throughout a majority of a given product run. Traditional feedback loops yield a significant volume of unusable product, requiring a considerable amount of recycling of product. Continually recycling product can also result in longer exposure times to heat, resulting in an overcooked product with inferior organoleptic properties.

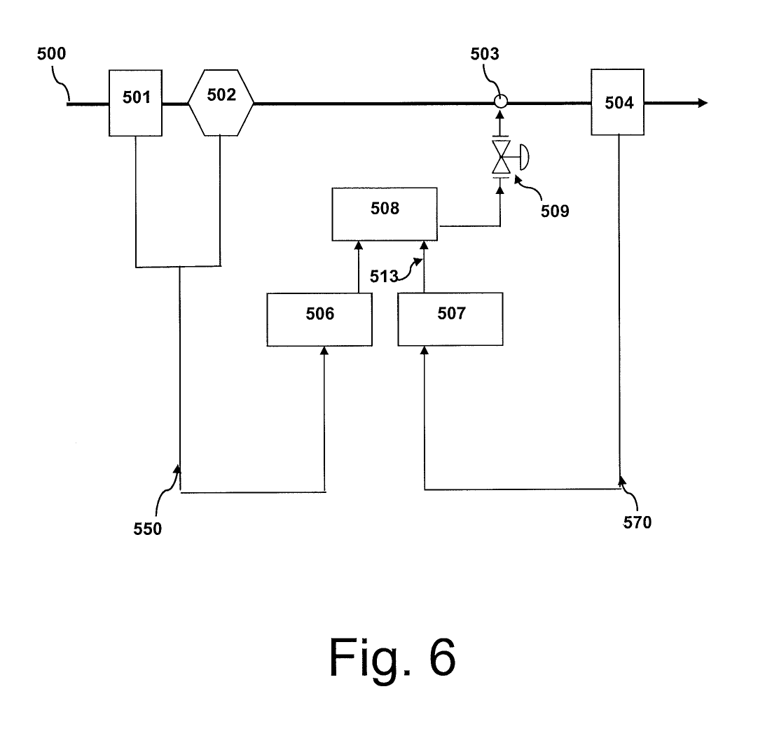

A flow-diagram of one type of feed-forward system is shown in FIG. 6. The illustrated embodiment contains both a feed-forward loop (550) for making coarse adjustments to steam flow, as well as a feedback loop (570) for later making fine adjustments based on performance of the feed-forward loop. The juice flow path (500) passes first through a first temperature monitor (501) and first flow rate monitor (502) located upstream from the point of steam injection (503). The first temperature monitor (501) and first flow rate monitor (502) comprise part of the feed-forward loop. Data from first temperature monitor (501) and first flow rate monitor (502) is sent to a coarse control subsystem (506). The coarse control subsystem (506) analyzes data relating to juice flow rate and temperature, and based on the juice temperature and flow rate calculates a desired release rate of steam that will raise the juice to a target pasteurization/sterilization temperature. The coarse control subsystem (506) then sends a control signal to a valve control system (508) that opens or closes one or more valves (509) in an amount sufficient to achieve the calculated steam flow rate. Steam is injected from valve(s) (509) directly into the juice stream at point (503) in order to heat the juice. Heated juice flows past a second temperature monitor (504), which comprises part of the fine adjustment feedback system. Data collected from the second temperature monitor (504) is transmitted to a fine control subsystem (507) through a feedback loop (570). The fine control subsystem (507) transmits a control signal along control circuit (513) to the steam release valve control system (508). If the temperature measured by temperature monitor (504) indicates that the steam-heated juice is outside of the acceptable range, or near the edge of the acceptable range, the control signal will cause steam release valve control system (508) to open or close the valve (509) in an amount effective to raise or lower the juice injected with steam at point (503) to achieve the preset target temperature. Since the position of the valve (509) was previously calculated to achieve heating of the juice to the preset target temperature, only minor adjustments from fine control subsystem (507) should be necessary.

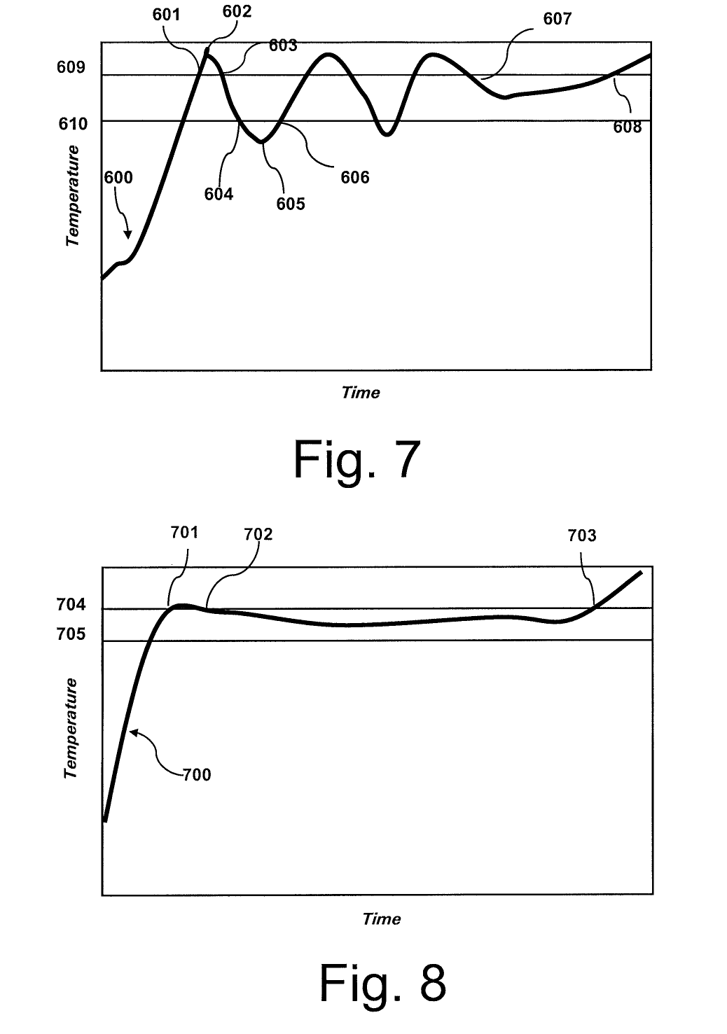

The benefits of the feed-forward control system are illustrated by FIGS. 7 and 8. FIG. 7 shows a representative heating curve from a system using conventional feedback control. The upper and lower boundaries of the acceptable pasteurization range are shown by (609) and (610), respectively. Heating curve (600) indicates the temperature of the steam-pasteurized juice stream (y-axis) at any given point in time during a production run (x-axis). During the startup phase, the juice is rapidly heated so that it approaches the target range. At point (601), the feedback control loop recognizes that the juice temperature has reached the maximum acceptable temperature, and a control signal is sent to reduce the flow of steam into the juice flow path. Simultaneously, a control signal is sent to a divert valve to divert the juice stream to a drain or other disposal unit, or possibly a juice recycling pathway. Until the control signal can reduce the flow of steam, the juice temperature continues to rise. At point (602), the adjustments to the steam release control valve have taken effect, and begin to lower the temperature of the juice. Eventually, at point (603), the juice temperature again reaches the acceptable target range, and a signal is sent to the divert valve to stop diverting product to the drain. Since the adjustments to the steam control valve were unlikely to be exactly those necessary to reach the target temperature, the juice temperature will continue to decrease until it reaches the lower boundary of the acceptable target range. At point (604), the feedback control loop again recognizes that the juice has reached the limit of the appropriate range, and sends a control signal to the steam release valve effective to increase the flow of steam. A second control signal causes product to be diverted to the drain. At point (605), this increased flow of steam begins to raise the juice temperature, and at point (606), the juice has once again reached an acceptable range, and the diverting of juice to the drain is ceased. This process of adjusting steam flow continues throughout processing, and eventually at point (607) the system reaches an optimum range. Between points (607) and (608), product is produced according to specification, until the system is shut down and the remaining steam raises the temperature of the equipment above the maximum temperature (609) as the flow of juice is diverted back to recycle mode. Shortly thereafter, juice production is shut down so that the system may be cleaned.

FIG. 8 illustrates the gains in efficiency by using a feed-forward system. Heating curve (700) indicates the temperature of the steam-pasteurized juice stream (y-axis) at any given point in time during a production run (x-axis). The feed-forward control loop calculates the amount of steam required to raise the juice to the target temperature range between upper boundary (704) and lower boundary (705). This results in a more controlled heating curve than that of a feedback-only system. When the juice temperature reaches a boundary of the acceptable target range, as at point (701), only fine adjustments are required to bring the juice temperature back into the acceptable range. This more controlled heating assures that much more of the production run will yield acceptable product, and further wastes less energy by avoiding intermittent overheating of the product. In this case, the entire run between points (702) and (703) yields acceptable product, whereas in a feedback-only system, as shown in FIG. 7, significant volumes of juice must be diverted to the drain due to unacceptable pasteurization conditions.

The feed-forward system may also comprise a number of additional control subsystems. The critical aspect of such a system, however, is that it measures the flow rate and temperature of a juice stream in order to provide coarse adjustments to a downstream heat source, in this case a steam injector.

A high temperature direct steam injection apparatus also may be configured to employ a number of additional control loops, not only to maintain a given temperature, but also to maintain a given flow of the feed streams of juice and other components, to maintain a constant Brix, to maintain a set pressure at the point of steam injection, and to take into account the dilution of the juice stream caused by a given flow rate of steam (which will condense into water as it cools). A system of divert valves with feedback control loops also are preferably incorporated throughout the flow paths in order to discard or recycle any fluid that does not meet pre-set temperature target ranges and pre-set flow rate ranges at various points throughout the system.

The following example is meant to illustrate aspects of the disclosed invention, and is in no way meant to limit the disclosure:

### EXAMPLE

A finished juice product was prepared by continuously blending three streams of liquid: hot juice concentrate (treated with direct steam injection), high fructose corn syrup, and hot water. A stream of juice concentrate compound held at about 20° F. to 70° F. was passed through a tube at approximately 0.3 gallons per minute and sterilized by direct steam injection at 255° F. for 3.5 seconds at 100 psig. The resulting stream of sterilized juice compound was continuously blended with a stream of high fructose corn syrup (HFCS) with a flow rate of approximately 2.5 gallons per minute and a temperature of about 90° F. and a stream of hot water with a flow rate of approximately 17 gallons per minute at a temperature of 195° F. The finished product was pasteurized at about 185° F. to about 195° F. for about 2 seconds. The high temperature of all components achieved combination of the three streams and pasteurization of the finished product all in one step. If the stream of juice concentrate did not reach at least 250° F. (within 5° F. of the target sterilization temperature), divert valves were to release the juice concentrate stream into a drain for disposal. Similarly, if target pasteurization of the finished product was not achieved, the product was to be diverted to the drain for disposal.

Juice concentrate was held in a 50 gallon holding tank. The high fructose corn syrup was maintained in a 100 gallon tank connected to the juice heating apparatus downstream from the point of steam injection. A positive displacement pump, Micro Motion meter to monitor flow rate, and a divert valve, and a control system capable of adjusting flow rate were linked to the HFCS tank. Hot water was contained in a 150 gallon tank, and was heated using a plate and frame heat exchanger. Similar to the HFCS tank, the hot water tank included a centrifugal pump, a Micro Motion meter (which was used, as both a flow mater and thermometer), a control valve, a divert valve, and a control system, and was connected to the juice heating apparatus downstream from the point of steam injection.

A Brix control loop controlled the Brix of the finished juice product. A Brix meter was positioned upstream of the finished product divert valve, and diverted finished juice product to the drain if it did not meet the specified Brix tolerance. A Brix controller changed the set point of hot water flow rate in order to maintain the desired Brix.

The juice making process began by blending a juice concentrate compound and separately filling the juice concentrate, HFCS, and hot water tanks. Hot water temperature was controlled by a temperature control loop in the hot water tank. A hot water stream was started in recycle mode to establish a target flow rate and temperature (about 17 gpm at about 195° F.). Likewise, the HFCS stream started in recycle mode to establish its target flow rate and temperature (about 2.5 gpm at about 90° F.). The juice stream began in cold juice recycle mode (about 20-70° F.) to establish a target flow rate and temperature. The steam injection zone was pre-sterilized at about 255° F. prior to the release of the juice stream. Steam condensed in the holding tubes and was discharged as waste water by a divert valve located downstream of the steam injection zone. A cold water stream was opened downstream from the steam injection zone in order to cool the steam before it is diverted to the drain.

Once the steam injection zone had been sterilized and had reached about 255° F., valves connected to the juice holding tank were switched from cold recycle mode to forward mode, releasing a stream of juice concentrate toward the steam injection zone. Steam nearly instantaneously penetrated the juice concentrate and was dispersed, efficiently mixing with the concentrate and ensuring homogeneous and rapid heating to precise pasteurization temperatures. Once the juice compound reached a temperature of approximately 245° F. due to the addition of high temperature steam, the post-injection zone divert valve was closed and hot juice concentrate flows downstream towards an in-line static mixer. If the temperature of the juice stream fell below the set lower tolerance (approximately 245° F.), the divert valve re-opened and diverted juice to the drain until the problem was corrected. Valves connected to the HFCS and hot water holding tanks were switched from recycle mode to forward mode, and streams of HFCS and hot water were combined with the sterilized hot juice stream prior to entry into the static mixer.

The static mixer contained 4 helical mixing elements, and was configured in-line with the product flow in order to minimize impedance of product flow. The three streams of liquid were continuously blended in the static mixer to produce a finished juice product. Contact with the lower temperature components quickly cooled the hot juice concentrate, and the finished juice product was guided to a temperature monitor and an in-line Brix monitor. If the product did not meet pre-set temperature and Brix specifications, product was diverted until the problems was corrected.

Orange juice prepared according to the above method was shown to not only meet the organoleptic standards of traditionally pasteurized orange juice, but was actually shown to be preferred over traditionally pasteurized orange juice. In a 150 participant blind study, 58% (87 individuals) indicated a preference for orange juice prepared by steam injection, while only approximately 29% (43 individuals) preferred traditionally pasteurized orange juice, and approximately 13% (20 individuals) were indifferent. Statistical analysis of this data shows a significant preference for the direct steam injected product.

While the invention herein has been particularly described with specific reference to particular embodiments, it will be appreciated that various alterations, modifications, and adaptations may be made based on the present disclosure, and are intended to be within the spirit and scope of the present invention as defined by the following claims.

What is claimed is:

1. A method for sterilizing a flowable food product that may contain a target microbe, the method comprising:
heating the flowable food product to a preset elevated temperature of at least 245° F. by direct steam injection to form a steam-heated flowable food product;
holding the steam-heated flowable food product at about the preset elevated temperature for no longer than 30 seconds under a pressure of about 25 to about 35 psig;
cooling the steam-heated flowable food product by direct injection of a cooling liquid to a temperature below about 195° F. within about 5 seconds or less to form a finished food product.

2. The method of claim 1 wherein the step of holding the heated flowable food product at about the preset elevated temperature takes place in an in-line static mixer.

3. The method of claim 2 wherein the finished food product passes through an in-line static mixer after the step of direct injection of the cooling liquid.

4. The method of claim 1 wherein the target microbe is Alicyclobacillus acidoterrestris, and the aqueous based flowable food product is a fruit juice, fruit concentrate, fruit puree, or vegetable juice.

5. The method of claim 3 wherein the target microbe is Alicyclobacillus acidoterrestris, and the aqueous based flowable food product is a fruit juice, fruit concentrate, fruit puree, or vegetable juice.

6. A method of controlling a direct steam injection pasteurization process comprising:
measuring a first flow rate and first temperature of a liquid feed stream;
using the measured first flow rate and the first temperature of the liquid feed stream to calculate a second flow rate of steam effective to raise the liquid feed stream to a temperature within a first preset target temperature range when the steam is injected into the feed stream;
transmitting a control signal representative of the calculated second flow rate of steam effective to raise the liquid feed stream to the second temperature within the preset target temperature range to a steam injection control system;
using the steam injection control system to vary a steam output of a source of steam so that the output of the source of steam matches the calculated second flow rate of steam effective to raise the liquid feed stream to the second temperature within the first preset target temperature range; and
directing the liquid feed stream toward the source of steam so that the liquid feed stream comes into direct physical contact with the steam output of the source of steam, whereby the liquid feed stream forms a heated liquid stream with a temperature within the first preset target temperature range.

7. The method of claim 6 further comprising:
measuring a temperature of the heated liquid stream;
using the temperature of the heated liquid stream to calculate a steam treatment adjustment effective to alter the temperature of the heated liquid stream to a temperature within a second preset target temperature range if the temperature of the heated liquid stream is not within the preset target temperature range;
transmitting a feedback control signal to the steam injection control system representative of the calculated steam treatment adjustment;
adjusting the steam output of the source of steam based on the calculated steam treatment adjustment.

8. The method of claim 7 wherein the second preset target temperature range is the same as the first preset target temperature range.

9. The method of claim 8 wherein the second preset target temperature range is within the first preset target temperature range.

10. A method of pasteurizing a beverage product comprising:
injecting a first liquid with steam in an amount effective to raise the temperature of the liquid to a first predetermined temperature of at least about 250° F. to form a first heated liquid;
maintaining a second liquid at a second predetermined temperature below the temperature of the first heated liquid;
maintaining a third liquid at a third predetermined temperature below the temperature of the first heated liquid;
combining the first heated liquid, second liquid, and third liquid to form a heated beverage product, wherein the first heated liquid, second heated liquid, and third-liquid are combined in such a manner that the resulting heated beverage product will have a temperature of at least 190° F.; and
cooling the heated beverage product to form a finished beverage product.

11. The method of claim 10 further comprising:
blending the first heated liquid in an in-line static mixer prior to combining the first heated liquid, second liquid, and third liquid; and
blending the heated beverage product in an in-line static mixer.

12. The method of claim 11 further comprising packaging the finished beverage product.

13. The method of claim 11, wherein the step of packaging the finished beverage product comprises a hot fill packaging process, cold fill process, or aseptic packaging process

14. A steam injection device comprising:
a steam release orifice;
a piston capable of being linearly inserted into the steam release orifice;
a tapered contact surface on the piston that contacts the steam release orifice to close the orifice;
wherein removal of the piston from the orifice along a linear pathway forming a longitudinal axis of the piston creates an annular opening between the steam release orifice and the piston.
